(19) United States
(12) Patent Application Publication
(10) Pub. No.: US 2016/0380329 A1
(43) Pub. Date: Dec. 29, 2016

(54) WAVEGUIDE STRUCTURE AND METHOD FOR MANUFACTURING THE SAME

(71) Applicant: KYOCERA Corporation, Kyoto-shi (JP)

(72) Inventors: Makoto SHIROSHITA, Otsu-shi (JP); Kazuki HAYATA, Yamatokoriyama-shi (JP)

(73) Assignee: KYOCERA Corporation, Kyoto-shi (JP)

(21) Appl. No.: 15/189,392

(22) Filed: Jun. 22, 2016

(30) Foreign Application Priority Data
Jun. 24, 2015 (JP) 2015-126538

(51) Int. Cl. H01P 3/16; H01P 11/00

(52) U.S. Cl. CPC H01P 3/16; H01P 11/006

(57) ABSTRACT

A waveguide structure of the present disclosure includes a first conductor layer, a plurality of dielectric strips which are formed so as to extend adjacently to one another on the upper surface of the first conductor layer, and a second conductor layer formed on the upper surface of the first conductor layer so as to cover the upper and side surfaces of the dielectric strips.

### BACKGROUND OF THE INVENTION

1. Technical Field

The present invention relates to a waveguide structure for transmitting high-frequency electromagnetic waves and a method for manufacturing the waveguide structure.

2. Background

As a transmission line for transmitting high-frequency electromagnetic waves such as microwaves and millimeter waves, a waveguide structure having a structure in which the space inside a conductor pipe having a rectangular cross section is filled with a dielectric is known. A wiring board having such a waveguide structure is disclosed in Japanese Unexamined Patent Publication No. H11-97854 for example. In recent years, with the performance enhancement and miniaturization of electronic devices in which the waveguide is employed, it is required to place a plurality of waveguides in high density in order to simultaneously transmit a plurality of electromagnetic waves.

### SUMMARY

A waveguide structure according to the present disclosure includes a first conductor layer, a plurality of dielectric strips which are formed so as to extend adjacently to one another on the upper surface of the first conductor layer, and a second conductor layer formed on the upper surface of the first conductor layer so as to cover the upper and side surfaces of the dielectric strips.

A method for manufacturing a waveguide structure according to the present disclosure includes forming a plurality of dielectric strips extending adjacently to one another on the upper surface of the first conductor layer and forming a second conductor layer on the upper surface of the first conductor layer so as to cover the upper and side surfaces of the dielectric strips.

### BRIEF DESCRIPTION OF THE DRAWINGS

FIG. 1 is a schematic cross-sectional view showing an embodiment of a waveguide structure according to the present disclosure;

FIGS. 2A to 2D are schematic cross-sectional views showing an embodiment of a method for manufacturing a waveguide structure according to the present disclosure;

FIGS. 3E to 31 are schematic cross-sectional views showing an embodiment of a method for manufacturing a waveguide structure according to the present disclosure; and

FIG. 4 is a schematic cross-sectional view showing another embodiment of a waveguide structure according to the present disclosure.

### DETAILED DESCRIPTION

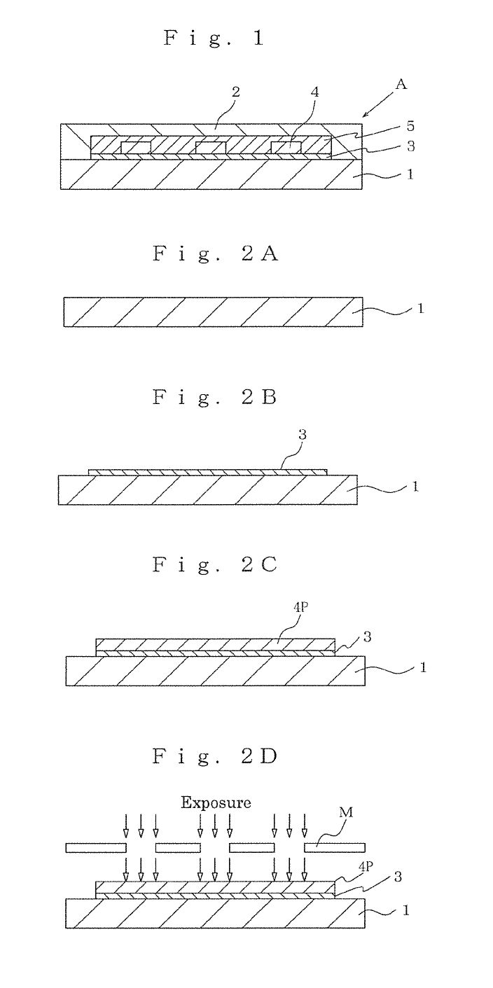

First, one embodiment of a waveguide structure according to the present disclosure will be described with reference to FIG. 1. A waveguide structure of the one embodiment is formed in an insulating board A having a structure in which a first insulating layer 1 and a second insulating layer 2 are stacked as shown in FIG. 1. The waveguide structure of the one embodiment includes a first conductor layer 3 and dielectric strips 4 and a second conductor layer 5.

The first and second insulating layers 1 and 2 are formed of a thermosetting resin such as an epoxy resin and a bismaleimide triazine resin. The first conductor layer 3 is formed of a highly conductive material such as electroless plating and electrolytic plating. The first conductor layer 3 is formed of an electroless copper plating or electrolytic copper plating in a flat shape for example, on the first insulating layer 1. The first conductor layer 3 may have a thickness of about 1 to 10 μm, for example.

The dielectric strip 4 is formed of an electrical insulating material such as an epoxy resin, an acrylic resin and a fluorine resin, and has a rectangular cross section. The dielectric strip 4 may have a width of 1.45 mm or more. When the dielectric strip 4 has a width of 1.45 mm or more, an electromagnetic wave of 60 GHz or more for example, is easily transmitted with a low loss. Further, the dielectric strip 4 may have a width 1.65 mm or less. When the dielectric strip 4 has a width of 1.65 mm or less, a small-sized high-density waveguide structure can be achieved, for example. The dielectric strip 4 may have a thickness of about 0.3 to 1.0 mm, for example.

To reduce the loss of the transmitted electromagnetic waves further, the dielectric loss tangent (tanδ) of the electrical insulating material used as a dielectric strip 4 may be 0.01 or less. To miniaturize the waveguide further, the relative permittivity (εr) of the electrical insulating material used as a dielectric strip 4 may be 2 or more. Furthermore, in order to reduce the loss of the transmitted electromagnetic waves further, the relative permittivity (εr) of the electrical insulating material used as the dielectric strip 4 may be 10 or less.

The second conductor layer 5 is formed on the first conductor layer 3 so as to cover the upper and side surfaces of the dielectric strip 4. That is, the second conductor layer 5 is formed so as to fill the gap between the dielectric strips 4, and to cover the upper and side surfaces of the dielectric strips 4. The second conductor layer 5 that fills the gap between the dielectric strips 4, i.e. the gap between dielectric strips 4 may have a width of 0.4 μm or more. When the gap between the dielectric strips 4 has a width of 0.4 μm or more, electromagnetic waves transmitting through respective dielectric strips 4 are easily prevented from interfering with each other. Furthermore, in order to obtain more compact and high-density waveguides, the gap between dielectric strips 4 may have a width of 500 μm or less. The thickness of the second conductor layer 5 is not particularly limited, as long as the thickness can allow the second conductor layer 5 to cover the upper and side surfaces of the dielectric strips 4.

As described above, according to the waveguide structure of the present disclosure, gaps between a plurality of the dielectric strips 4 are filled with the second conductor layer 5. Thus, the distance between the dielectric strips 4 can be reduced. Accordingly, a waveguide structure in which a plurality of waveguides are arranged densely can be provided.

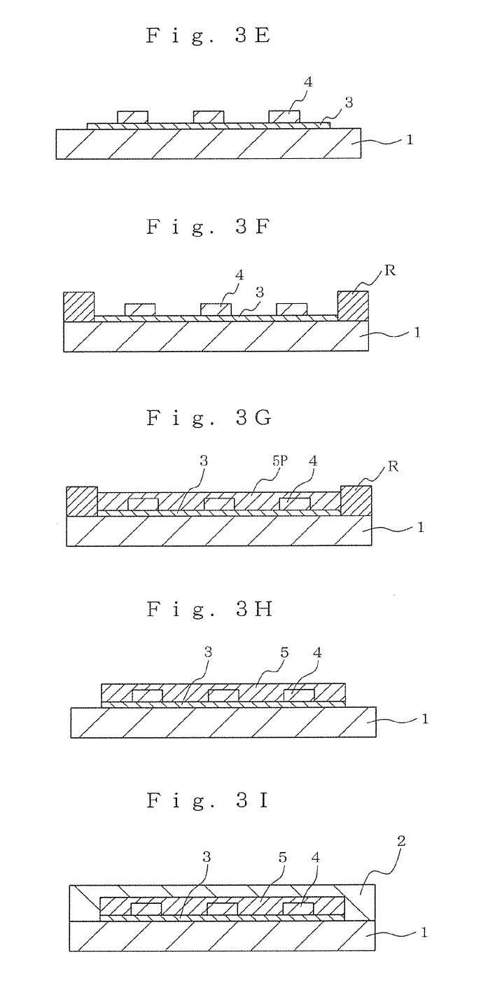

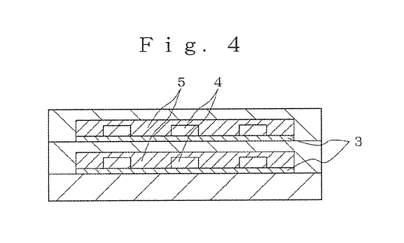

Next, one embodiment of a method for manufacturing the waveguide structure according to the present disclosure will be described with reference to FIGS. 2A to 2D and FIGS. 3E to 31. The same portions as FIG. 1 are denoted by the same reference characters and detailed description thereof will be omitted.

First, as shown in FIG. 2A, the first insulating layer 1 is prepared. The first insulating layer 1 is formed by pressing an electrical insulating film with a flat plate while heating, for example. The electrical insulating film is formed of a thermosetting material such as an epoxy resin and a bismaleimide triazine resin.

As shown in FIG. 2B, the first conductor layer 3 is formed on the first insulating layer 1. The first conductor layer 3 is formed by depositing an electroless copper plating (not shown) on the first insulating layer 1 and depositing the electrolytic copper plating thereon, for example. As described above, the first conductor layer 3 may have a thickness of about 1 to 10 μm.

As shown in FIG. 2C, a dielectric 4P having photosensitivity, for example, is deposited. The dielectric 4P is formed of an electrical insulating material such as an epoxy resin, an acrylic resin and a fluorine-containing resin. The dielectric 4P may have a thickness of about 0.3 to 1.0 mm, for example. Next, a part of the dielectric 4P is exposed to light by placing a mask M having openings corresponding to the regions where the dielectric strips 4 are to be formed, above the dielectric 4P as shown in FIG. 2D.

As shown in FIG. 3E, dielectric strips 4 are formed by developing the unexposed portions of the dielectric 4P. Each gap between the dielectric strips 4 may have a width of 0.4 μm or more as described above, and may have a width of 500 μm or less. Further, the dielectric strip 4 may have a width of 1.45 mm or more as described above, and may have a width of 1.65 mm or less.

As shown in FIG. 3F, plating resists R exposing the first conductor layer 3 and the dielectric strips 4 are formed on the first insulating layer 1. Next, as shown in FIG. 3G, a plating metal layer 5P forming the second conductive layer 5 is deposited so as to fill gaps between the dielectric strips 4 and to cover the upper and side surfaces of the dielectric strips 4.

As shown in FIG. 3H, the second conductor layer 5 formed on the first conductor layer 3 so as to cover the upper and side surfaces of the dielectric strips 4 is obtained by removing the plating resists R. The second conductor layer 5 that has filled the gap between dielectric strips 4 may have a width of 0.4 μm or more and may also have a width of 500 μm or less as described above.

Finally, by stacking a second insulating layer 2 on the first insulating layer 1, as shown in FIG. 3I, an insulating board A having a waveguide structure shown in FIG. 1 is formed. The second insulating layer 2 is formed by pressing an electrical insulating film with a flat plate while heating after the film is subjected to vacuum pressure bonding on the first insulating layer 1. The electrical insulating film is formed of a thermosetting material such as an epoxy resin and a bismaleimide triazine resin, as described above.

Thus, according to the method for manufacturing the waveguide structure relating to the present disclosure, after forming a plurality of dielectric strips 4 extending adjacently to one another, the gap between the dielectric strips 4 is filled with the second conductor layer 5. Thus, since the gap between the dielectric strips 4 can be reduced, a method for manufacturing the waveguide structure in which a plurality of waveguides can be placed in high density can be provided.

The waveguide structure and the method for manufacturing the waveguide structure in the present disclosure are not limited to the above-described embodiments, and various modifications are possible without departing from the scope of the present disclosure.

For example, the waveguide structure according to the one embodiment described above has a single-stage structure. However, as shown in FIG. 4, the waveguide structure may have a multistage structure.

For example, in the method for manufacturing according to the one embodiment described above, the dielectric strips 4 are formed by light exposure and development of the photosensitive dielectric 4P. However, dielectric strips 4 may be formed by performing blast treatment for example, after curing the entire dielectric 4P.

For example, the waveguide structure according to the one embodiment described above uses dielectric strips 4 each having a rectangular cross section. However, the shape of the cross section of the dielectric strip is not particularly limited, and the dielectric strip may have a shape of a cross section other than a rectangle such as a polygonal shape and a circular shape.

What is claimed is:

1. A waveguide structure comprising:
a first conductor layer;
a plurality of dielectric strips formed so as to extend adjacently to one another on an upper surface of the first conductor layer; and
a second conductor layer formed on the upper surface of the first conductor layer so as to cover upper and side surfaces of the dielectric strips.

2. The waveguide structure according to claim 1, wherein each of the dielectric strips has a quadrangular cross section.

3. The waveguide structure according to claim 2, wherein each of the dielectric strips has a width of 1.45 mm or more.

4. The waveguide structure according to claim 1, wherein each gap between the dielectric strips has a width of 0.4 μm or more.

5. A method for manufacturing a waveguide structure comprising:
forming a plurality of dielectric strips extending adjacently to one another on an upper surface of a first conductor layer; and
forming a second conductor layer on the upper surface of the first conductor layer so as to cover upper and side surfaces of the dielectric strips.

6. The method for manufacturing according to claim 5, wherein each of the dielectric strips has a quadrangular cross section.

7. The method for manufacturing according to claim 6, wherein each of the dielectric strips has a width of 1.45 mm or more.

8. The method for manufacturing according to claim 5, wherein each gap between the dielectric strips has a width of 0.4 μm or more.
